(19) United States
(12) Patent Application Publication
(10) Pub. No.: US 2008/0144498 A1
(43) Pub. Date: Jun. 19, 2008

(54) Bandwidth reservation system and method for dynamic channel switching and computer readable recording medium

(75) Inventors: Hsin-Pu Chung, Taipei City (TW); Yen-Ying Wu, Taipei City (TW); Hua-Chieh Chen, Taipei City (TW)

Correspondence Address: RABIN & Berdo, PC, 1101 14TH STREET, NW, SUITE 500, WASHINGTON, DC, 20005, US

(73) Assignee: INSTITUTE FOR INFORMATION INDUSTRY, Taipei City (TW)

(21) Appl. No.: 11/649,202

(22) Filed: Jan. 4, 2007

(30) Foreign Application Priority Data
Dec. 13, 2006 (TW) 095146756

(51) Int. Cl. H04L 12/56

(52) U.S. Cl. 370/231

(57) ABSTRACT

A bandwidth reservation system and method for dynamic channel switching, and a computer readable recording medium are provided. The bandwidth reservation system includes a transmitting terminal, for selecting a first channel from a plurality of channels to establish a connection, and detecting the other channels and selecting a second channel for switching and then establishing a new connection for data transmission, when the first channel does not have sufficient bandwidth for reservation; a receiving terminal, for establishing the connection with the transmitting terminal and receiving the data transmitted from the transmitting terminal, and switching to the second channel according to the requirement of the transmitting terminal, so as to establish the connection and to perform the data transmission. The bandwidth reservation system and method are capable of providing and ensuring the quality of service (QoS) of the connection for real-time service, and improving the bandwidth utilization of the whole network.

### CROSS-REFERENCE TO RELATED APPLICATIONS

This non-provisional application claims priority under 35 U.S.C. § 119(a) on Patent Application No(s). 095146756 filed in Taiwan, R.O.C. on Dec. 13, 2006, the entire contents of which are hereby incorporated by reference.

### BACKGROUND OF THE INVENTION

1. Field of Invention

The present invention relates to a bandwidth reservation method, and more particularly, to a bandwidth reservation method for dynamically switching channels on an Ultra-Wide Band (UWB) network.

2. Related Art

Ultra-Wide Band (UWB) is a short-distance wireless communication technology with low power and high data transmission rate, and it is also a new wireless communication process using a bandwidth between 3.1 GHz and 10.6 GHz, which is mainly derived from the radar system technique used in the U.S. military laboratory in 1960s. The UWB is characterized in that, the emitted impulse is extremely narrow, and the band is up to 7500 MHz, and thus, it has advantages of high transmission rate, low power consumption, and high safety. As long as the width of the emitted impulse is controlled below 1 ns, a communication capability over 1 Gbps can be achieved theoretically, and the current UWB technology has supported a transmission rate of over 100 Mbps. The specification of the UWB is mainly instituted by two alliances, i.e., Multiband OFDM Alliance (WiMedia-MBOA) and UWB Forum, who respectively support different techniques. As for the MBOA UWB specification instituted by WiMedia-MBOA, the transmission rate is up to 480 Mbps, together with the Distributed Reservation Protocol (DRP), a user can reserve the bandwidth for a certain period of time in the channel, such that the distributed wireless network can ensure the Quality of Service (QoS) for transmission. Therefore, the MBOA UWB is applicable for the real-time service requiring a large bandwidth and a preferable QoS, such as interactive audio/videos, network televisions, or network telephones.

DRP protocol adopts a reservation manner, and the users respectively divide the required bandwidth and the interval according to their individual demands. FIG. 1 is a schematic view of the DRP protocol of UWB. Referring to FIG. 1, the UWB divides the available band into 5 channels, after the device is turned on, a channel is selected and added, and a time synchronization operation is performed. A collection composed of devices in the same channel is referred to as a Beacon Group, each device in the Beacon Group has the capability of reserving the bandwidth, and once the bandwidth is reserved, it cannot be occupied by other device. A channel is divided into a plurality of accessing periods according to the time, which is referred to as super frames, as shown in FIG. 1, the length of one super frame is 65536 microseconds (μs). A beacon period 110 (BP) is planned at the beginning of each super frame, and all the devices must send a beacon in this period. If one device does not send any beacon in the subsequent several BPs, the device is considered as leaving the Beacon Group. The time period of the super frame 100, after the BP 110 is subtracted, can be used as a bandwidth for reservation of the device.

As the number of the devices increases, there are more and more intervals occupied by the reservation in the channel, which causes that there is no sufficient interval for the subsequently added device to reserve. As shown in FIG. 1, it is assumed that the devices DV1, DV2, and DV3 respectively reserve corresponding reservation intervals 120, 130, and 140, each reservation interval is 30000 μs, and the length of BP is defaulted as 1000 μs. After the devices DV1, DV2 have reserved the corresponding reservation intervals 120, 130, the length of the remained interval 150 of the super frame is not sufficient for the reservation of the device DV3, and thus, the QoS of the device DV3 cannot be ensured. If the device DV3 needs to wait for the release of the occupied bandwidth, a delay problem occurs, and if the device DV3 provides a service of video, the circumstance of image or voice interruption will occur, which is not allowed by the real-time service or the image streaming service. Particularly, when network congestion occurs, the above problem that the transmission QoS of the connection for the real-time service cannot be ensured becomes more obvious. Therefore, a bandwidth reservation technology capable of resolving the above bandwidth reservation problem is required by UWB.

### SUMMARY OF THE INVENTION

In view of the above problems, the present invention is directed to providing a bandwidth reservation system and method for dynamic channel switching, which can ensure that the data transmission is not interrupted through dynamically detecting and real-time switching, thereby solving the problem in the prior art that the QoS of data transmission for the real-time connection cannot be ensured once network congestion occurs.

In order to achieve the above objective, the present invention can be achieved in the forms of both system and method. The bandwidth reservation system for dynamic channel switching disclosed in the preset invention comprises: a transmitting terminal, for selecting a first channel from a plurality of channels to establish a connection for transmitting data, wherein the transmitting terminal reserves bandwidth through a first bandwidth reservation record in a first beacon of the first channel; and a receiving terminal, for establishing the connection with the transmitting terminal in the first channel and receiving the data.

If it is determined that an available bandwidth in the first bandwidth reservation record is not sufficient for the reservation of the transmitting terminal, the transmitting terminal sequentially scans a second beacon corresponding to the other channels, and if it is determined that there is sufficient bandwidth for the reservation of the transmitting terminal in a second bandwidth reservation record of a second channel of the channels, the transmitting terminal transmits a channel switching request to the receiving terminal, such that the transmitting terminal and the receiving terminal establish a new connection for transmitting data continuously after being switched to the second channel.

In the bandwidth reservation system for dynamic channel switching according to the preferred embodiment of the present invention, the transmitting terminal declares the bandwidth reservation in the first channel or the second channel through a Distributed Reservation Protocol (DRP).

In the bandwidth reservation system for dynamic channel switching according to the preferred embodiment of the present invention, the receiving terminal returns a channel switching response to the transmitting terminal upon receiving the channel switching request transmitted from the transmitting terminal, so as to inform the transmitting terminal to switch the channel, and the channel switching request and the channel switching response include fields, such as a transmitting terminal address, a receiving terminal address, a second channel (a channel to be switched), a countdown, a duration, and a state record.

The bandwidth reservation method for dynamic channel switching disclosed in the present invention is applicable for performing data transmission between a transmitting terminal and a receiving terminal over an ultra-wide band (UWB) wireless personal area network (WPAN), which at least comprises the following steps: first, the transmitting terminal and the receiving terminal select a first channel and establish a connection; next, the transmitting terminal determines whether the bandwidth of the first channel is sufficient for reservation through a first bandwidth reservation record of the first beacon; then, if the first available bandwidth is not sufficient for the reservation of the transmitting terminal, the transmitting terminal checks whether a second channel with sufficient bandwidth for the reservation of the transmitting terminal exists or not among other channels; then, the transmitting terminal determines the second channel to which a second available bandwidth sufficient for the reservation of the transmitting terminal belongs, and sends a channel switching request to the receiving terminal, so as to inform the receiving terminal to switch to the second channel; and finally, the transmitting terminal declares an interval to be reserved in the second channel, so as to perform data transmission.

In the bandwidth reservation method for dynamic channel switching according to the preferred embodiment of the present invention, the process for scanning the second beacon corresponding to other channels further comprises three modes.

(1) After transmitting a first beacon at the beginning of a beacon period in each super frame, the transmitting terminal is idled in the first channel, and turns to scan the second beacon of the other channels, and determines through the second bandwidth reservation record in the second beacon whether there is a sufficient space for the transmitting terminal to declare the interval to be reserved.

(2) After transmitting a first beacon, the transmitting terminal does not transmit the first beacon within a time period of a plurality of super frames (e.g., between 1 and 3 super frames), turns to scan the second beacon of the other channels, and determines through the second bandwidth reservation record in the second beacon whether there is a sufficient space for the transmitting terminal to declare the interval to be reserved.

(3) After transmitting a first beacon, the transmitting terminal declares entering into a hibernation mode, turns to scan the second beacon of the other channels, and determines through the second bandwidth reservation record in the second beacon whether there is a sufficient space for the transmitting terminal to declare the interval to be reserved.

In the bandwidth reservation method for dynamic channel switching according to the preferred embodiment of the present invention, the step of switching the transmitting terminal and the receiving terminal to the second channel to perform data transmission further comprises: first, the transmitting terminal and the receiving terminal leave the first channel; next, the transmitting terminal selects a second channel, determines and adds a beacon group of the second channel; then, a beacon group is established, if the transmitting terminal determines the beacon group does not exist; then, the receiving terminal enters into the second channel, and adds the beacon group to which the transmitting terminal belongs; and finally, the receiving terminal and the transmitting terminal establish the connection, and perform data transmission.

The bandwidth reservation method for dynamic channel switching also may be executed through a computer program code recorded in a computer readable recording medium.

Briefly, in the present invention, through the technique of dynamic channel switching, if the selected channel does not have sufficient bandwidth for the reservation of the transmitting terminal, the transmitting terminal and the receiving terminal are capable of being switched to a channel with sufficient bandwidth for the bandwidth reservation, so as to establish a connection for data transmission. Therefore, the problem that the QoS cannot be ensured once an over congestion occurs in a network with a single channel is solved, and the bandwidth utilization of each channel is increased, and thereby enhancing the performance of the whole network.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below for illustration only, and thus are not limitative of the present invention, and wherein:

FIG. 1 is a schematic view for reserving bandwidth in a super frame;

FIG. 2 is a schematic view of a bandwidth reservation system for dynamic channel switching according to an embodiment of the present invention;

FIG. 3 is a schematic view of fields contained in the first beacon according to an embodiment of the present invention;

FIG. 4 is a flow chart of a bandwidth reservation method for dynamic channel switching according to the present invention;

FIG. 5A is a schematic view of the transmitting terminal scanning other channels according to a first embodiment of the present invention;

FIG. 5B is a schematic view of the transmitting terminal scanning other channels according to a second embodiment of the present invention;

FIG. 5C is a schematic view of the transmitting terminal scanning other channels according to a third embodiment of the present invention; and

FIG. 6 is a schematic view of the bandwidth reservation method for dynamic channel switching according to an embodiment of the present invention.

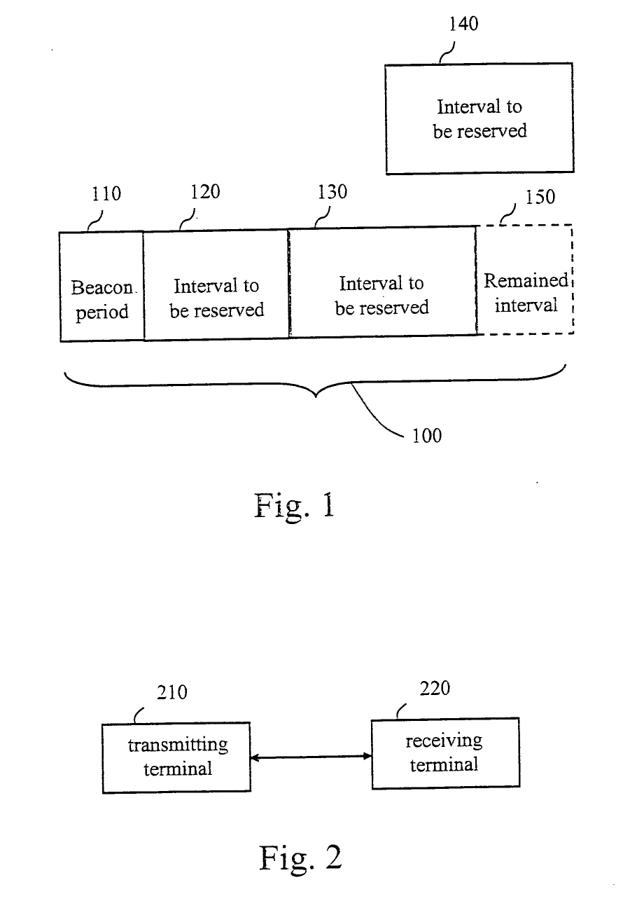

### DETAILED DESCRIPTION OF THE INVENTION

The objectives and implementation of the present invention are illustrated below in detail through the following preferred embodiments. However, the concepts of the present invention also can be used in other scopes. The embodiments listed below are only used to illustrate the objective and implementation of the present invention, but not to limit the scope thereof.

FIG. 2 is a schematic view of a bandwidth reservation system for dynamic channel switching according to an embodiment of the present invention. Referring to FIG. 2, in this embodiment, the bandwidth reservation system for dynamic channel switching (briefly referred as this system hereinafter) is applicable for data transmission in an ultra-wide band (UWB) wireless personal area network, and this system includes a transmitting terminal 210 and a receiving terminal 220. According to a standard specification, the UWB network can divide all available bandwidths into a plurality of channels, at the very beginning, the transmitting terminal 210 can select to add one channel (a first channel) by itself, and make an agreement with the receiving terminal 220 to establish a connection in the first channel, so as to transmit data. In the UWB network, the transmitting terminal can reserve a period of time (referring to an interval to be reserved) in the first channel through a Distributed Reservation Protocol (DRP), so as to transmit data. Before the transmitting terminal 210 declares the interval to be reserved, it is required to check whether the first channel has sufficient bandwidth for reservation. In this embodiment, the transmitting terminal 210 can determine whether there is sufficient bandwidth for reservation through a first bandwidth reservation record in a first-beacon in the first channel. The receiving terminal 220 is used to establish a connection with the transmitting terminal 210 in the first channel (or in another same channel), and receive the data transmitted from the transmitting terminal 210.

Subsequently, the transmitting terminal 210 determines whether the bandwidth of the first channel is sufficient for the reservation of the transmitting terminal 210 through an available bandwidth in the first bandwidth reservation record. If the transmitting terminal 210 determines that the bandwidth is not sufficient for reservation, the transmitting terminal 210 sequentially scans a second beacon corresponding to the other channels, and when it determines that a second bandwidth reservation record in the second beacon of a second channel among the channels has sufficient bandwidth for the reservation of the transmitting terminal 210, the transmitting terminal 210 transmits a channel switching request to the receiving terminal 220, so as to be switched to the second channel. After being switched to the second channel, the transmitting terminal 210 and the receiving terminal 220 establish a connection for transmitting data in the second channel.

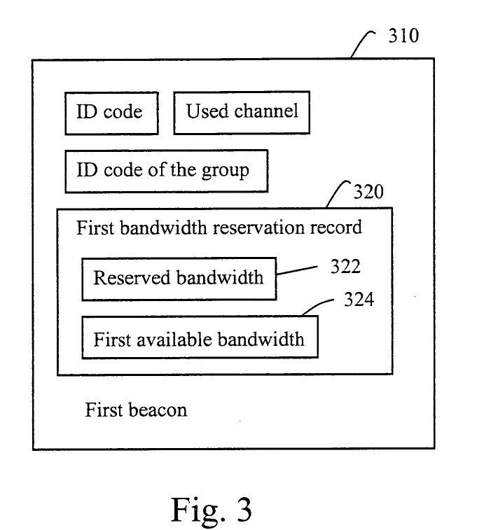

In addition, formats of the first beacon and the second beacon are shown in FIG. 3, and FIG. 3 is a schematic view of fields contained in the first beacon according to of an embodiment the present invention. In this embodiment, besides an ID code of the transmitting terminal, a used channel, and an ID code of the group, the first beacon 310 transmitted by the transmitting terminal in the first channel further includes a first bandwidth reservation record 320. The first bandwidth reservation record 320 includes fields such as a reserved bandwidth 322 and a first available bandwidth 324, which respectively record the reserved part of the bandwidth and the currently available part of the bandwidth in the first channel, and the interval to be reserved declared by the transmitting terminal is recorded in the reserved bandwidth 332. It can be derived that, the second beacon scanned/transmitted by the transmitting terminal in the other channels also as least includes the second bandwidth reservation record, the reserved bandwidth, and a second available bandwidth. By transmitting the first beacon and the second beacon, the transmitting terminal can inform other devices about the information such as the group which it belongs to, the reserved bandwidth, and reserve an interval to be reserved in the first channel or the second channel for the subsequent data transmission.

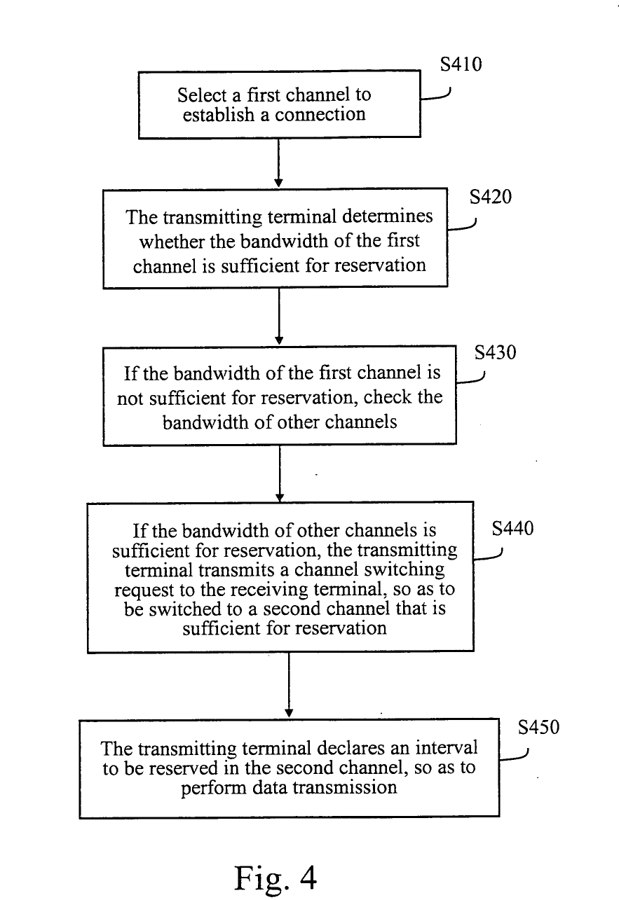

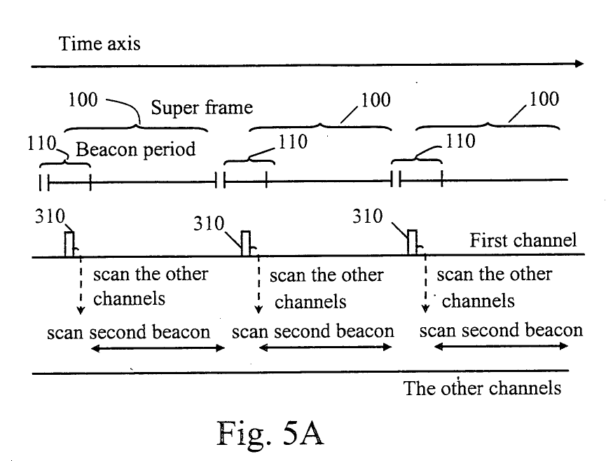

The bandwidth reservation method for dynamic channel switching of this embodiment is illustrated below. FIG. 4 is a flow chart of the bandwidth reservation method for dynamic channel switching according to the present invention. Referring to FIG. 4, the bandwidth reservation method for dynamic channel switching of this embodiment at least includes the following steps. First, the transmitting terminal and the receiving terminal select a first channel from a plurality of channels to add, and establish a connection, so as to perform data transmission (S410). Next, the transmitting terminal reads a first beacon of the first channel, and determines whether the bandwidth of the first channel is sufficient for reservation or not through a first available bandwidth in a first bandwidth reservation record contained in the first beacon (S420). Then, if the first available bandwidth is not sufficient for the reservation of the transmitting terminal, the transmitting terminal sequentially scans a second beacon corresponding to the other channels, and determines a bandwidth sufficient for the reservation of the transmitting terminal through a second available bandwidth of a second bandwidth reservation record in the second beacon (S430). Then, the transmitting terminal determines a second channel to which the second available bandwidth sufficient for reservation belongs, and transmits a channel switching request to the receiving terminal, so as to inform the receiving terminal to switch to the second channel (S440). Finally, in Step E, the transmitting terminal declares an interval to be reserved in the second channel, and the transmitting terminal and the receiving terminal perform the data transmission during the interval to be reserved (S450).

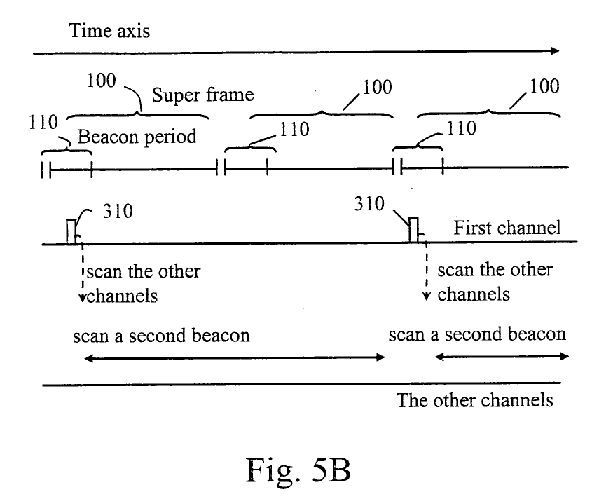

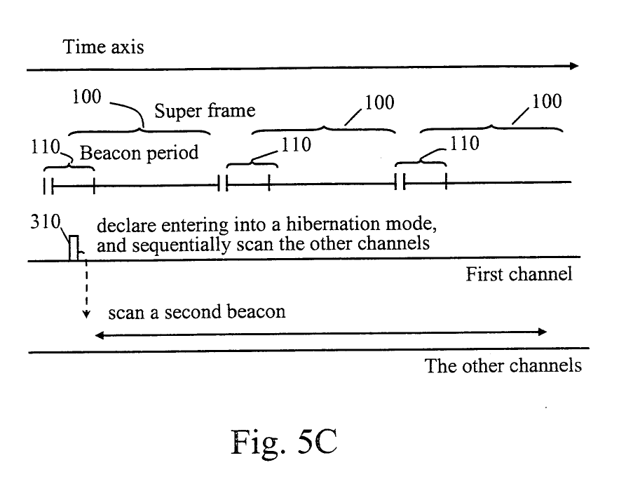

The above step that the transmitting terminal sequentially scans the second beacon corresponding to the other channels (S430) can be achieved through three modes listed in this embodiment, which are not intended to limit the scope thereof. FIG. 5A is a schematic view of the transmitting terminal scanning other channels according to a first embodiment of the present invention, FIG. 5B is a schematic view of the transmitting terminal scanning other channels according to a second embodiment of the present invention, and FIG. 5C is a schematic view of the transmitting terminal scanning other channels according to a third embodiment of the present invention. Referring to FIG. 2 and FIG. 5A together, when the transmitting terminal 210 determines that the first channel does not have sufficient bandwidth for reservation, it turns to scan the other channels after transmitting a first beacon 310 in the beacon period 110 of each super frame 100. Since the beacon periods of other channels are not limited to be synchronous with that of the first channel (most of them are not synchronous), a second beacon of the other channels can be scanned (not shown in FIG. 5A). With the second available bandwidth (not shown in FIG. 5A) in the second bandwidth reservation record contained in the second beacon, the transmitting terminal can determine that a second channel corresponding to the second beacon has sufficient bandwidth for reservation. Once the super frame is ended, the transmission terminal turns to return to the first channel and then transmits the first beacon 310 again. Through the above method, the transmitting terminal can sequentially scan the other channels without leaving the beacon group to which the first channel is added, so as to find out an available channel (a channel with sufficient bandwidth for the reservation of the transmitting terminal).

In the UWB network, it is allowable that one (or more) member in the beacon group does not transmit any beacon within a time period of a plurality of super frames, and the member is removed after exceeding a specific time period of super frames. Referring to FIG. 5B, another mode for the transmitting terminal to scan other channels in this embodiment includes scanning the other channels after transmitting the first beacon 310, and turning back to the first channel to transmit the first beacon 310 after a time period of a plurality of super frames. The allowable time period of super frames in this embodiment is between 1 and 3 super frames. As for FIG. 5B, the transmitting terminal only needs to transmit the first beacon 310 once during every other super frames in the first channel, and it scans the second beacon of the other channels during the remaining time, so as to find the second channel with sufficient bandwidth for reservation.

In addition, during the time period that one (or more) member in the beacon group declares entering into a hibernation mode, the beacon is not required to be transmitted, and after the hibernation mode is ended, the membership of the beacon group can be maintained without being removed from the beacon group. After the transmitting terminal and the receiving terminal declare entering into the hibernation mode, and switch to the second channel with sufficient bandwidth for reservation to finish the data transmission, the transmitting terminal and the receiving terminal will not be removed from the original beacon group due to leaving the first channel for an excessive long time, but instead, they can conveniently return to the original beacon group at any time.

Referring to FIG. 5C, the transmitting terminal uses the characteristic of the hibernation mode, and declares entering into the hibernation mode after transmitting the first beacon 310. During the hibernation mode, the transmitting terminal turns to sequentially scan the second beacon of the other channels, and determines whether there is sufficient bandwidth for the reservation of the transmitting terminal through the second available bandwidth in the second bandwidth reservation record of the second beacon, so as to find out the corresponding second channel.

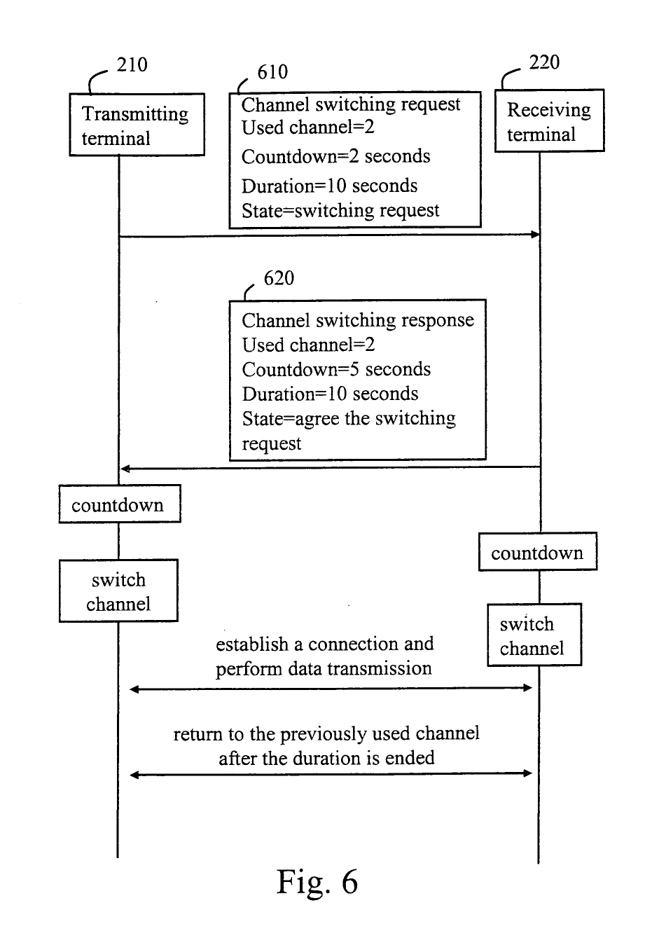

In order to illustrate the process for switching from the first channel to the second channel in an embodiment of the present invention more clearly, an example is recited as follows. FIG. 6 is a schematic view of the bandwidth reservation method for dynamic channel switching according to an embodiment of the present invention. Referring to FIG. 6, after the transmission terminal 210 determines that the second channel has sufficient bandwidth for reservation, it starts to switch to this channel. First, the transmitting terminal 210 transmits a channel switching request 610 to the receiving terminal 220, the channel switching request 610 includes a used second channel (used channel), a countdown of the transmitting terminal 210, a duration after switching to the second channel, and a responded state. After the receiving terminal 220 receives the channel switching request, it responds with a channel switching response 620, which includes fields of information that are the same as that of the channel switching request. For example, in this embodiment, the transmitting terminal 210 takes Channel 2 as the second channel with sufficient bandwidth, and informs the receiving terminal 220 through the channel switching request 610 to perform the switching after a countdown of 2 seconds, with the duration in the second channel of 10 seconds. After the receiving terminal 220 receives the channel switching request 610, it informs the transmitting terminal 210 through a channel switching response 620 about the agreement of the channel switching request 610 and using Channel 2 as the second channel, and informs the transmitting terminal 210 to switch to the second channel after a countdown of 5 seconds. After receiving the channel switching response 620, the transmitting terminal 210 starts to countdown and then, it is switched to the second channel; the receiving terminal 220 starts to countdown and then, it is switched to the second channel after transmitting the channel switching response 620. After being switched to the second channel, the transmitting terminal 210 and the receiving terminal 220 establish a connection for performing data transmission, and they return to the previous first channel after the duration is ended (or after the data transmission is finished).

Then, the step of switching the transmission terminal and the receiving terminal to the second channel as mentioned in FIG. 6 includes the following steps. First, the transmitting terminal 210 and the receiving terminal 220 leave the first channel; then, the transmitting terminal 210 selects a second channel, and adds in a beacon group of the second channel, wherein if there is no beacon group in the second channel, the transmitting terminal 210 establishes a beacon group. Then, the receiving terminal 220 enters into the second channel after finishing the countdown, and adds in the beacon group to which the transmitting terminal 210 belongs. Finally, the receiving terminal 220 and the transmitting terminal 210 establish a connection, and thereby finishing the data transmission. The transmitting terminal 210 and the receiving terminal 220 are not limited to leave the first channel or enter into the second channel through the above process. In some embodiments, the transmitting terminal 210 and the receiving terminal 220 can leave the first channel simultaneously and then enter into the second channel simultaneously. In this embodiment, in order to avoid generating two different beacon groups after the transmitting terminal 210 and the receiving terminal 220 entering into the second channel simultaneously (if the second channel has no device or any beacon group, adding both of them in the second channel simultaneously may generate a plurality of beacon groups), a countdown is specifically set, such that the transmitting terminal 210 establishes or adds into a beacon group in the second channel in advance, and then, the receiving terminal 220 searches the beacon group to which the transmitting terminal 210 belongs and adds in the beacon group, so as to ensure that both the transmitting terminal 210 and the receiving terminal 220 are in the same beacon group. The switching process is only illustrated as an embodiment, and other methods can be derived by any skilled in the art, which is not limited herein.

By the way, in this embodiment, the transmitting terminal declares an interval to be reserved in the first channel or the second channel through, for example, DRP. The process for declaring the interval to be reserved is only illustrated as an example, which is not limited herein either.

To sum up, in the bandwidth reservation system and method for dynamic channel switching of the present invention, the transmitting terminal and the receiving terminal can dynamically switch the channels, and the system and method of the present invention at least has the following advantages.

(1) If it is detected that the currently available channel has no bandwidth for reservation, the transmitting terminal immediately detects the bandwidth of the other channels, so as to perform data transmission through another bandwidth, thereby avoiding waiting for the release of the network resources once network congestion occurs.

(2) Once network congestion occurs, the QoS of the connection between the transmitting terminal and the detecting terminal also can be ensured.

(3) The bandwidth utilization of the whole network is improved, and the data volume that can be transmitted by the connection is also enhanced.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A bandwidth reservation system for dynamic channel switching, applicable for data transmission over an ultra-wide band (UWB) wireless personal area network (WPAN), comprising:
a transmitting terminal, for selecting a first channel from a plurality of channels to establish a connection for transmitting data, wherein the transmitting terminal reserves bandwidth through a first bandwidth reservation record in a first beacon of the first channel; and
a receiving terminal, for establishing the connection with the transmitting terminal in the first channel and receiving the data;
wherein, if it is determined that an available bandwidth in the first bandwidth reservation record is not sufficient for the reservation of the transmitting terminal, the transmitting terminal sequentially scans a second beacon corresponding to the other channels, and after it is determined that there is a sufficient bandwidth for the reservation of the transmitting terminal in a second bandwidth reservation record of a second channel of the channels, the transmitting terminal transmits a channel switching request to the receiving terminal, and thus, after switching to the second channel, the transmitting terminal and the receiving terminal establish a connection for transmitting data.

2. The bandwidth reservation system for dynamic channel switching as claimed in claim 1, wherein the transmitting terminal and the receiving terminal are switched back to the first channel after the data transmission through the second channel is finished.

3. The bandwidth reservation system for dynamic channel switching as claimed in claim 1, wherein the transmitting terminal declares the bandwidth reservation in the first channel or the second channel through a Distributed Reservation Protocol (DRP).

4. The bandwidth reservation system for dynamic channel switching as claimed in claim 1, wherein after receiving the channel switching request from the transmitting terminal, the receiving terminal returns a channel switching response for informing the transmitting terminal to switch the channel.

5. The bandwidth reservation system for dynamic channel switching as claimed in claim 1, wherein the channel switching request and the channel switching response comprise a transmitting terminal address, a receiving terminal address, a second channel, a countdown, a duration, and a state record.

6. A bandwidth reservation method for dynamic channel switching, applicable for data transmission between a transmitting terminal and a receiving terminal over a UWB WPAN, at least comprising:
(A) the transmitting terminal and the receiving terminal selecting a first channel from a plurality of channels, and establishing a connection;
(B) the transmitting terminal reading a first beacon of the first channel, and determining whether the bandwidth of the first channel is sufficient for reservation through a first available bandwidth in a first bandwidth reservation record of the first beacon;
(C) if the first available bandwidth is not sufficient for the reservation of the transmitting terminal, the transmitting terminal sequentially scanning a second beacon corresponding to the other channels, and determining a bandwidth sufficient for the reservation of the transmitting terminal through a second available bandwidth in a second bandwidth reservation record of the second beacon;
(D) determining a second channel to which the second available bandwidth sufficient for the reservation of the transmitting terminal belongs, and sending a channel switching request to the receiving terminal, so as to inform the receiving terminal to switch to the second channel; and
(E) the transmitting terminal declaring an interval to be reserved in the second channel, and the transmitting terminal and the receiving terminal performing data transmission in the interval to be reserved.

7. The bandwidth reservation method for dynamic channel switching as claimed in claim 6, wherein the transmitting terminal declares the interval to be reserved in the first channel or the second channel through a DRP.

8. The bandwidth reservation method for dynamic channel switching as claimed in claim 6, wherein Step (C) further comprises: the transmitting terminal sequentially scans the second bandwidth reservation record of the second beacon except the other channels, after transmitting the first beacon in the beacon period of each super frame, so as to determine the interval to be reserved.

9. The bandwidth reservation method for dynamic channel switching as claimed in claim 6, wherein Step (C) further comprises: the transmitting terminal does not transmit the first beacon in the time period of several super frames, but sequentially scans the second bandwidth reservation record of the second beacon except the other channels, so as to determine the interval to be reserved.

10. The bandwidth reservation method for dynamic channel switching as claimed in claim 9, wherein the time period of the super frames falls between 1 and 3 super frames.

11. The bandwidth reservation method for dynamic channel switching as claimed in claim 6, wherein Step (C) further comprises: the transmitting terminal declares entering into a hibernation mode, and sequentially scans the second bandwidth reservation record of the second beacon except the other channels, so as to determine the interval to be reserved.

12. The bandwidth reservation method for dynamic channel switching as claimed in claim 6, wherein Step (D) further comprises: the receiving terminal transmits a channel switching response to the transmitting terminal, so as to inform the transmitting terminal to start to switch to the second channel.

13. The bandwidth reservation method for dynamic channel switching as claimed in claim 6, wherein the channel switching request and the channel switching response comprise a transmitting terminal address, a receiving terminal address, a second channel, a countdown, a duration, and a state record.

14. The bandwidth reservation method for dynamic channel switching as claimed in claim 6, wherein the step of switching the receiving terminal and the transmitting terminal to the second channel in Step (D) comprises:
the transmitting terminal and the receiving terminal leaving the first channel;
the transmitting terminal selecting the second channel;
determining and adding a beacon group of the second channel;
establishing the beacon group, if it is determined that the beacon group does not exist;
the receiving terminal entering into the second channel, and adding the beacon group to which the transmitting terminal belongs; and
the receiving terminal and the transmitting terminal establishing a connection, and performing data transmission.

15. The bandwidth reservation method for dynamic channel switching as claimed in claim 6, wherein Step (E) further comprises: after the transmitting terminal and the receiving terminal declare entering into the hibernation mode, and switched to the second channel to finish the data transmission, the transmitting terminal and the receiving terminal are switched back to the first channel.

16. A computer readable recording medium, applicable for storing a computer program code executable by a computer, the computer program code at least executes the following operations:
(A) the transmitting terminal and the receiving terminal selecting a first channel from a plurality of channels, and establishing a connection;
(B) the transmitting terminal reading a first beacon of the first channel, and determining whether the bandwidth of the first channel is sufficient for reservation through a first available bandwidth in a first bandwidth reservation record of the first beacon;
(C) if the first available bandwidth is not sufficient for the reservation of the transmitting terminal, the transmitting terminal sequentially scanning a second beacon corresponding to the other channels, and determining a bandwidth sufficient for the reservation for the transmitting terminal through a second available bandwidth in a second bandwidth reservation record of the second beacon;
(D) determining a second channel to which the second available bandwidth sufficient for the reservation of the transmitting terminal belongs, and sending a channel switching request to the receiving terminal, so as to inform the receiving terminal to switch to the second channel; and
(E) the transmitting terminal declaring an interval to be reserved in the second channel, and the transmitting terminal and the receiving terminal performing data transmission in the interval to be reserved.

17. The computer readable recording medium as claimed in claim 16, wherein the transmitting terminal declares the interval to be reserved in the first channel or the second channel through a DRP.

18. The computer readable recording medium as claimed in claim 16, wherein Step (C) further comprises: the transmitting terminal sequentially scans the second bandwidth reservation record of the second beacon except the first channel, after transmitting the first beacon in the beacon period of each super frame, so as to determine the interval to be reserved.

19. The computer readable recording medium as claimed in claim 16, wherein Step (C) further comprises: the transmitting terminal does not transmit the first beacon within a time period of several super frames, but sequentially scans the second bandwidth reservation record of the second beacon except the first channel, so as to determine the interval to be reserved.

20. The computer readable recording medium as claimed in claim 19, wherein the time period of the super frames falls between 1 and 3 super frames. 21. The computer readable recording medium as claimed in claim 16, wherein Step (C) further comprises: the transmitting terminal declares entering into a hibernation mode, and sequentially scans the second bandwidth reservation record of the second beacon except the first channel, so as to determine the interval to be reserved.

22. The computer readable recording medium as claimed in claim 16, wherein Step (D) further comprises: the receiving terminal transmits a channel switching response to the transmitting terminal, so as to inform the transmitting terminal to start to switch to the second channel.

23. The computer readable recording medium as claimed in claim 16, wherein the channel switching request and the channel switching response comprise a transmitting terminal address, a receiving terminal address, a second channel, a countdown, a duration, and a state record.

24. The computer readable recording medium as claimed in claim 16, wherein the step of switching the receiving terminal and the transmitting terminal to the second channel in Step (D) comprises:
the transmitting terminal and the receiving terminal leaving the first channel;
the transmitting terminal selecting the second channel;
determining and adding a beacon group of the second channel;
establishing the beacon group, if it is determined that the beacon group does not exist;
the receiving terminal entering into the second channel, and adding the beacon group to which the transmitting terminal belongs; and
the receiving terminal and the transmitting terminal establishing the connection, and performing data transmission.

25. The computer readable recording medium as claimed in claim 16, wherein Step (E) further comprises: after the transmitting terminal and the receiving terminal declare entering into the hibernation mode, and switched to the second channel to finish the data transmission, the transmitting terminal and the receiving terminal are switched back to the first channel.
